(19) United States
(12) Patent Application Publication
(10) Pub. No.: US 2007/0081655 A1
(43) Pub. Date: Apr. 12, 2007

(54) Automatic dialing-up system for communication apparatus

(76) Inventors: Chung-Yo Sun, Jhudong Township (TW); Shih-Nan Chueh, Hsinchu City (TW)

Correspondence Address: J.C. Patents, Inc.;Suite 250, 4 Venture, Irvine, CA, 92618, US

(21) Appl. No.: 11/400,109

(22) Filed: Apr. 6, 2006

(30) Foreign Application Priority Data
Sep. 29, 2005 (TW) 94133939

(51) Int. Cl. H04M 3/42

(52) U.S. Cl. 379/218.01

(57) ABSTRACT

An automatic dialing-up system for communication apparatus is provided. The automatic dialing-up system uses a server and a communication apparatus to fulfill the services. The server at first obtains the job content of an interactive voice response system, then converts the job content into a corresponding form and finally generates a program suitable for the communication apparatus according to the form. The communication apparatus obtains and runs the program, so that the program is able to generate the corresponded dialing-up instruction code according to the keys entered by a user and the settings of the program itself and to automatically dial-up a dialing-up content including the dialing-up instruction codes and the user input data. Wherein, the form provides the dialing-up instruction code composed by at least an option in the job content and is stored in hierarchy mode expressed the relationships between all the options in the job content.

### CROSS-REFERENCE TO RELATED APPLICATION

This application claims the priority benefit of Taiwan application serial no. 94133939, filed on Sep. 29, 2005. All disclosure of the Taiwan application is incorporated herein by reference.

### BACKGROUND OF THE INVENTION 1. Field of Invention

The present invention relates to a dialing-up system, and particularly to an automatic dialing-up system for communication apparatus.

2. Description of the Related Art

Since the service-automation became one of the main streams in modern lives, voice response system has emerged as a service option to enable a customer to handle what he/she wants just by pressing keys several times. With considerable option items, the conventional voice response system would take a lot of time and, even worse, lead to ambiguous query communication due to the received messages with poor quality. The caused troubles for customers are excessive waiting time and too expensive calling fee, owing that some customers often take too much time on the telephone line and result in blocking the rest customers from connecting with the system. Surely, these customers shall complain with the service provider of the voice response system. Therefore, how to shorten the time wasted in a voice response system for customers has been becoming a high-priority issue to be solved.

U.S. patent publication No. 20040153322 provides an instrument to solve the above-described problem. An interactive voice response system has speak-ahead capabilities similar to type-ahead IVR systems by determining multi-level grammars for responses. Preferably, an existing IVR application is processed automatically to generate a multi-level grammar database that can then be used in recognizing multi-level responses by a user. Since the scheme relies on the speech recognition so much and, so far, the speech recognition technology can not get perfect recognition rate in some environmental condition, as a result it is not satisfactory enough by customers nowadays. Therefore, the scheme provided by U.S. patent publication No. 20040153322 doesn't completely solve the problem; probably, it maybe take more time for customers to stay on the telephone line.

### SUMMARY OF THE INVENTION

Based on the above described, an object of the present invention is to provide an automatic dialing-up system for communication apparatus which is suitable for affording an automatic dialing-up service corresponding to an interactive voice response system and effectively reducing the time required by communication.

Another object of the present invention is to establish a method for providing content required by the program used in a communication apparatus, wherein the method is capable of converting the content of a voice response system into a specific format, so that a programmer or a computer system is able to easily generate the program used in a communication apparatus by means of the format.

The present invention provides an automatic dialing-up system for communication apparatus which is suitable for affording an automatic dialing-up service corresponding to an interactive voice response system. The automatic dialing-up system employs a server and a communication apparatus to finish the service thereof. The server generates data suitable for the communication apparatus according to a form converted from job content of the interactive voice response system. The communication apparatus obtains the data so that the data can provide one of the parameters for generating a dialing-up instruction code. After that, all dialing-up instruction codes are integrated into a dialing-up content and the communication apparatus dials out according to the dialing-up contents. In one of the embodiment, the data described above can be a program suitable for operating in the communication apparatus or be the data stored for a program to use in the communication apparatus.

In an embodiment of the present invention, the above-described server further includes a smart learning unit. The smart learning unit records the voice data according to the hierarchy architecture of the interactive voice response system, then converts the voice data into a text file. After that, it determines the service points of the content in the converted text format, and confirms if each of the service points needs an input number, such as credit card number, phone number, or bank account number. Finally, according to the above-described hierarchy architecture it makes the results obtained by the service point decision being stored as a form file in the server.

The present invention further provides a method for affording content required by the program used in a communication apparatus. The method is used as a guideline for generating the codes used in a communication apparatus. The content includes three columns. They are the hierarchy column, the description column and the result column. These columns are used to define the structure of the interactive voice response system. The hierarchy column is used to keep track of the inheritance information of the data from the IVR system. The description column is used for affording the text corresponding to the correct level of the IVR system to be displayed on the communication apparatus. Finally, the result column is used for storing the dialing-up codes corresponding to the service of the IVR system.

In an embodiment of the present invention, the codes are programmed according to the hierarchy column on which the relationships between the services of the IVR system are based, the description column on which the displayed contents are based and the result column by which the dialing-up code and output data of the communication apparatus are determined.

The present invention uses a specific storage format, so that a form serving as a guideline to generate program is easily provided. In addition, the system could enable a user to connect the service automatically only as the user finishes the data input, It contributes a shorter communication time and a cheaper fee for customers and contributes to a less number of phone lines to be established for the IVR service provider.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a block diagram of an automatic dialing-up system according to an embodiment of the present invention.

FIG. 2 is a diagram showing a form outlook according to an embodiment of the present invention.

FIG. 3 is a diagram showing a form example, wherein the real content is listed according to an embodiment of the present invention.

FIG. 4 is an operation flow chart of an automatic smart learning according to an embodiment of the present invention.

### DESCRIPTION OF THE EMBODIMENTS

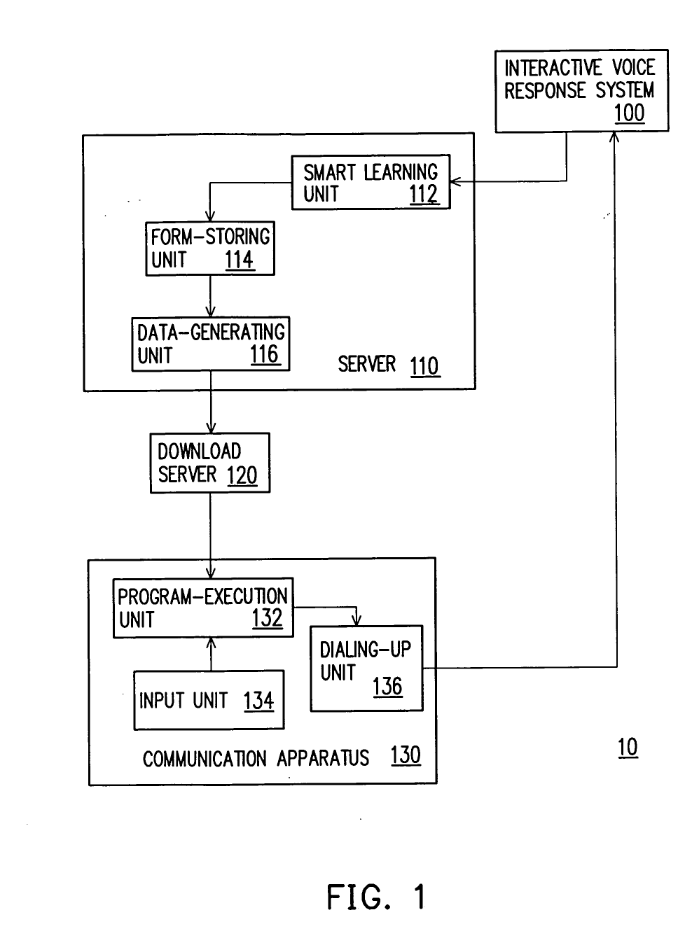

FIG. 1 is a block diagram of an automatic calling-up system according to an embodiment of the present invention. Referring to FIG. 1, an automatic dialing-up system 10 of the embodiment mainly uses a server 110 and a communication apparatus 130 to run. Between the server 110 and the communication apparatus 130, the automatic dialing-up system 10 further includes a download server 120 to enable the data to be sent to the communication apparatus 130 without disposing on too many servers 110. The download server can use any communication interface, for example, a bluetooth communication interface, a wireless network communication interface or an infrared communication interface, to perform a data communication. The transmission of program files and data content in the download server 120 can be performed by the communication interface such that data communication between the download server 120 and the server 110 or between the download server 120 and the communication apparatus 130 can be accomplished. In other words, the download server 120 is not essentially required component in the embodiment.

In the embodiment, the interactive voice response system 100 provides job content of a voice response service, which is converted into a form through learning function of a smart learning unit 112 and the form would be stored in a form-storing unit 114. In another embodiment however, the form stored in the form-storing unit 114 can be obtained in any other manners, not limited to the above-described smart learning unit 112.

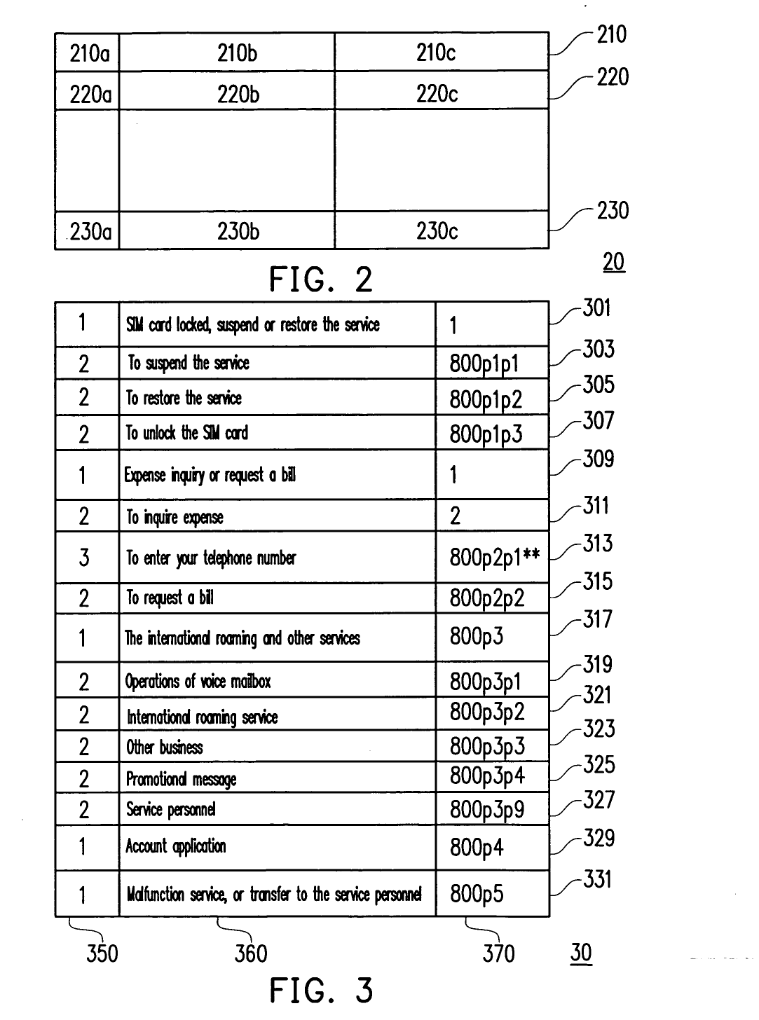

The form stored in the form-storing unit 114 has a specific format. The form indicates the relationships between any two options in the job content in hierarchy mode and provides dialing-up content corresponded by at least an option in the job content. FIG. 2 is a diagram showing a form outlook according to an embodiment of the present invention. The form 20 includes the content of a plurality of groups 210, 220 and 230. The content of each group includes a hierarchy column (210a, 220a or 230a), a description column (210b, 220b or 230b) and a result column (210c, 220c or 230c). Wherein, the hierarchy column is used for providing a relationship between the content of the group and the content of the other groups; the description column is used for providing a text corresponding to the content of the group and displayed on the communication apparatus; the result column is used for storing the dialing-up instruction code corresponding to the content of a group serving as the final chosen result.

For those skilled in the art to have a clearer picture about the form, it goes to FIG. 3. FIG. 3 is a diagram showing a form example, wherein the real content is listed according to an embodiment of the present invention. In the embodiment, the content of each group (301-331) of the form 30 includes a hierarchy column 350, a description column 360 and a result column 370, respectively. The figures stated in the hierarchy column 350 indicate which layer the option in an original voice response system belongs to. For example, an item 1 in the hierarchy column 350, or termed as hierarchy layer 1 hereinafter, indicates the choice belongs to the options of the first layer in the original voice response system, i.e. an option of the initial option menu generated just after dialing-up and getting a call. Similarly, an item 2 in the hierarchy column 350 indicates the choice belongs to the option menu of the next entered layer after selecting an option from the initial option menu. The other fields in the hierarchy column 350 can be understood in the similar way.

In comparison with the fields stored in the hierarchy column 350, the texts displayed on the communication apparatus are stored in the description column 360. For example, when the option menu of the first layer is displayed, all texts corresponding to all groups with the same layer item 1 (including 301, 309, 317, 329 and 331), respectively, and residing in the description column 360 appear on the communication apparatus. While selects 301, the texts corresponding to groups 303, 305 and 307, which are with the same layer item 2, respectively, and residing in the description column 360, appear on the communication apparatus. In the example, the contents in description column 360 corresponding to the groups 301-331 are following. 301 represents “SIM card locked, suspend or restore the service”. 303 represents “to suspend the service”. 305 represents “to restore the service”. 307 represents “to unlock the SIM card”. 309 represents “expense inquiry or request a bill”. 311 represents “to inquire expense”. 313 represents “to enter your telephone number”. 315 represents “to request a bill”. 317 represents “the international roaming and other services”. 319 represents “operations of voice mailbox”. 321 represents “international roaming service”. 323 represents “other business”. 325 represents “promotional message”. 327 represents “service personnel”. 329 represents “account application”. 331 represents “malfunction service, or transfer to the service personnel”.

As contrasted with the restrictive nature of the above-described two columns, the result column 370 has a somewhat flexibility to store the content. Only the result column 370 of the group corresponding to the real service point of each path is asked to store option result. The result column 370 corresponding to the other groups is available to additionally store any appropriate data. Further, in the embodiment, the groups taking a same path are arranged at the closest positions. In other words, all option menus are pop-up and browsed in a searching-tree and the searching-tree is evolutive according to the depth-first thereof. For example, the group 309 is one choice of the first layer, the groups 311 and 315 are the options of the second layer under the group 309 and the group 313 is the choice of the third layer under the group 311, thus the arrangement sequence of those groups are in this way: from the group 309, to the group 311, to the group 313.

It will be apparent to those skilled in the art that the arrangement and the content of the hierarchy column are not limited to the above-described manner. Any hierarchy items capable of recognizing the relationships between all options can be used in the hierarchy column 350. For example, the hierarchy items can be formed by combining a first item representing the sequence number of a hierarchy and a second item representing the option sequence. For example, the hierarchy items of the group 301 and the group 309 can be 1-1 and 1-2, respectively, which represent the first choice and the second choice of the first layer. While the hierarchy columns of the groups thereunder 303, 305, 307, 311 and 315 can be 1-1-1, 1-1-2, 1-1-3, 1-2-1 and 1-2-2, respectively. Wherein, 1-1-1, 1-1-2 and 1-1-3 represent three options of the second layer which is under the first choice of the first layer, i.e. the groups 303, 305 and 307. While 1-2-1 and 1-2-2 represent two options of the second layer under the second choice of the first layer, i.e. the groups 311 and 315, and so on.

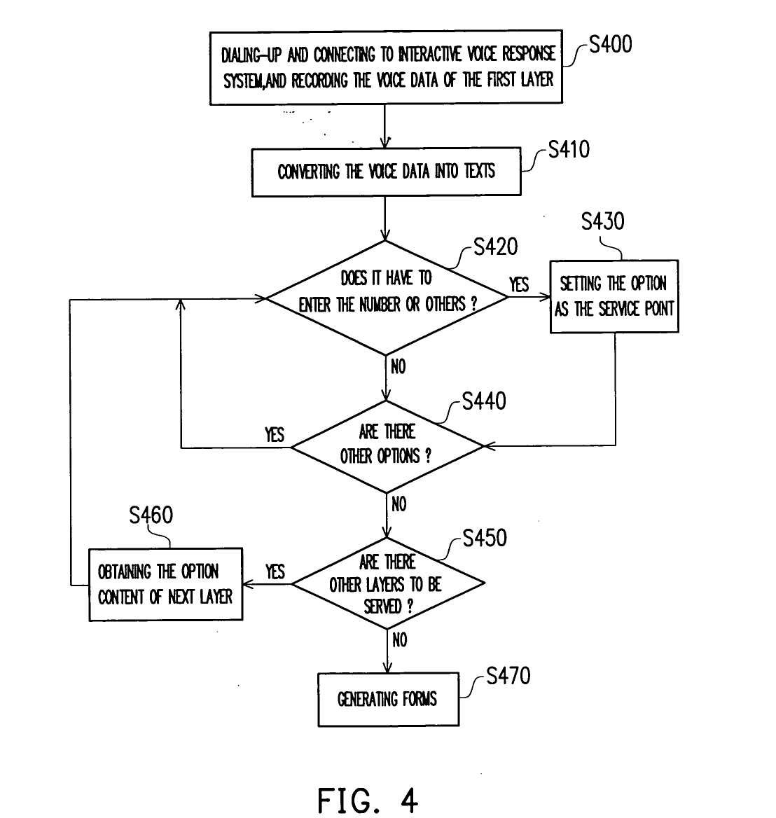

For a higher automation, a smart learning unit 112 shown in FIG. 1 is used for automatic capturing the voice content in the interactive voice response system. FIG. 4 is an operation flow chart of an automatic smart learning according to an embodiment of the present invention. Referring to FIG. 4, in the embodiment, the smart learning unit 112 or the server 110 is connected to an interactive voice response system with dialing-up. The voice data of the options of the first layer are recorded (step S400), then the voice data are converted into text (step S410) and all options are determined whether or not there is a requirement to enter any number or data (step S420 and S440). When there is a choice required entering additional data (for example, phone number, or birth date or identification number and so on), the choice is set in a form of an end point (or, in other names, a service point) (step S430). Once an option is set in the form of an end point, after selecting the choice to a program in the communication apparatus, a hint for a user to enter the relative information must be done, so that a dialing-up command is generated incorporating with the relative information.

After finishing the process commands of any one layer (if ‘No’ is concluded by the step S440), the next step is to determine whether or not the interactive voice response system includes the options of other layers lower than the present layer (step 450). If there are the options of other layers, the options must be obtained (step S460) to repeat the above-described processing operation of the end point. After the data of every layer are proceeded through the above-described steps, the smart learning unit would integrate the texts converted from the voice content, the hierarchy items where each option locates and a conclusion whether or not the option is a service point. Further, the form in the above-described format is generated to be exported to the form-storing unit 114. The data-generating unit 116 then generates the corresponded data according to the content of the form. The data can be a program suitable for operating in the communication apparatus 130 or be the data suitable for reading by a program in the communication apparatus 130. When generating a program from the form, the data-generating unit 116 functions just according to the hierarchy column on which the relationships between the options are based, according to the description column on which the display contents are based and according to the result column by which the dialing-up codes of the communication apparatus 130 are determined.

In the embodiment, the voice data are obtained sequentially. In fact, all the voice content can also be obtained at one time, followed by storing the voice content according to the hierarchy architecture formed by a layer sequence of options and further processing.

After the data generated in the above-described procedure or others are downloaded to the communication apparatus 130, the data can be executed by the program-execution unit 132 (when the data is a program) or the data are used as the parameters for running a program in the communication apparatus 130. The program-execution unit 132 generates dialing-up codes sequentially whenever the downloaded data are used for reading in a program or the data itself can be executed, the final dialing-up content can be decided according to the user input data in an input unit 134 and the settings of the data itself. The dialing-up content can be done through the dialing-up unit 136 and be delivered to the interactive voice response system 100 for connecting the exact service in the interactive voice response system 100 through a relative communication system. Furthermore, for user's convenience, the dialing-up content generated by the program every time, including the dialing-up number and the additional entered information required by all service points, can be stored in the communication apparatus 130 as shortcut commands such that the user can directly choose a shortcut command to perform the same function for dialing-up to the interactive voice response system 100 and obtaining the exact service without repeatedly proceeding the above mentioned operations.

It can be seen from the above described that the present invention uses a specific storage format, so that a form serving as a guideline to generate the program is easily provided. In addition, after converting the voice data of an interactive voice response system into texts enables a user to dial-up one time only as the user finishes the input selections. It contributes a shorter communication time and a cheaper communication fee for customers and contributes to the less number of phone lines to be established for the IVR service provider.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. An automatic dialing-up system for communication apparatuses, suitable for providing an automatic dialing-up service corresponding to an interactive voice response system, comprising:
a server, generating a data suitable for communication apparatuses according to a form converted from a job content of the interactive voice response system; and
a communication apparatus, used for obtaining the data, generating at least one corresponded dialing-up instruction code according to the data, integrating the dialing-up instruction code to form a dialing-up content and automatically dialing-up according to the dialing-up content.

2. The automatic dialing-up system for communication apparatuses as recited in claim 1, wherein the form comprises the content of a plurality of groups and the content of each group comprises, respectively:
a hierarchy column, used for providing the inheritance information between the group content and the other group content;
a description column, used for providing texts corresponding to the group content and being displayed on the communication apparatus; and
a result column, used for storing the corresponded dialing-up instruction code if the group content is concluded as the final chosen result.

3. The automatic dialing-up system for communication apparatuses as recited in claim 1, comprising a download server for storing the data and providing at least a transmission interface for the communication apparatus to download the data.

4. The automatic dialing-up system for communication apparatuses as recited in claim 3, wherein the transmission interface is a bluetooth communication interface.

5. The automatic dialing-up system for communication apparatuses as recited in claim 3, wherein the transmission interface is a wireless network communication interface.

6. The automatic dialing-up system for communication apparatuses as recited in claim 3, wherein the transmission interface is an infrared communication interface.

7. The automatic dialing-up system for communication apparatuses as recited in claim 1, wherein the data is suitable for reading by a program in the communication apparatus.

8. The automatic dialing-up system for communication apparatuses as recited in claim 1, wherein the data is a program to run in the communication apparatus.

9. The automatic dialing-up system for communication apparatuses as recited in claim 1, wherein the dialing-up content generated by the program is stored in the communication apparatus as a shortcut key.

10. The automatic dialing-up system for communication apparatuses as recited in claim 1, wherein the server further comprises a smart learning unit, used for conducting the following steps to convert the job content into a corresponding form:
according to a hierarchy architecture to record the voice data;
converting the voice data into texts;
deciding the service points of the job content; and
according to the hierarchy architecture storing the result obtained by the service point processing as the form.

11. A method for providing content required by generating program used in a communication apparatus, served as the guideline to generate a program used in a communication apparatus, comprising:
against the content of every group, providing a hierarchy column for recording the relationships between the content of the group and the content of the other groups;
against the content of every group, providing a description column for affording a text corresponding to the content of every group and displayed on the communication apparatus and;
against the content of every group, providing a result column for storing a corresponded dialing-up instruction code when the group content is concluded as the final chosen result.

12. The method for providing content required by the program used in a communication apparatus as recited in claim 11, wherein the program is generated according to the hierarchy column served as the base to design the option relationships.

13. The method for providing content required by the program used in a communication apparatus as recited in claim 11, wherein the program is generated according to the description column served as the base to design the displayed content.

14. The method for providing content required by the program used in a communication apparatus as recited in claim 11, wherein the program determines the dialing-up code of the communication apparatus according to the result column.

15. The method for providing content required by generating program used in a communication apparatus as recited in claim 11, wherein a form is generated by combining the content of a plurality of groups and the form is the base for generating the program.

16. The method for providing content required by the program used in a communication apparatus as recited in claim 11, wherein the content of any group is obtained by an interactive voice response system.

17. The method for providing content required by the program used in a communication apparatus as recited in claim 16, wherein the steps to obtain the content of any group from the interactive voice response system comprises:
according to a hierarchy architecture to record the voice data;
converting the voice data into texts;
deciding the service points of the job content and proceeding whether or not each service point needs to enter the number; and
taking the result obtained by the service point processing as the content of any one group.
